(19) United States
(12) Patent Application Publication
(10) Pub. No.: US 2006/0293960 A1
(43) Pub. Date: Dec. 28, 2006

(54) Interoperable account junctions and omnicompetent value trusts

(76) Inventor: Gregory Fx Iannacci, Winchester, MA (US)

Correspondence Address: GREGORY FX IANNACCI, 30 KEENE STREET, STONEHAM, MA, 02180, US

(21) Appl. No.: 11/474,832

(22) Filed: Jun. 26, 2006

Related U.S. Application Data
(60) Provisional application No. 60/694,718, filed on Jun. 28, 2005.

(51) Int. Cl. G06Q 30/00

(52) U.S. Cl. 705/14

(57) ABSTRACT

The present invention describes a system and method related to membership account management structures as used by issuers and applicants. Taken together, interoperable account junctions present a digest of how two or more participants involved in establishing membership accounts can normalize the information used in diverse subscription and maintenance functions.

### CROSS-REFERENCE TO RELATED APPLICATIONS

The present application claims priority from U.S. Provisional Application for Patent No. 60/694,718 filed 28 Jun. 2005 entitled Universal Application Interface and Settlement Account Gateway. Reference also is made to an earlier filed, pending application U.S. patent application Ser. No. 09/932,808 filed 17 Aug. 2001 entitled System and Method for an Automated Benefit Recognition, Acquisition, Value Exchange, and Transaction Settlement System Using Multivariable Linear and Nonlinear Modeling. The entirety of these patent applications is incorporated by reference herein.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention describes a system and method related to membership account management structures as used by issuers and applicants. Taken together, interoperable account junctions present a digest of how two or more participants involved in establishing membership accounts can normalize the information used in diverse subscription and maintenance functions. Interoperable account junctions and related data structures will: read and understand information requirements automatically; compare issuer data compliance needs to an applicant's own set of data precondition priorities; and, either provide appropriate data exchanges between parties in order to facilitate the operation of a membership account or inform the parties when precondition priorities do not match membership compliance standards.

The invention is useful in various applications including, for example, consumer reward accounts, financial accounts, and virtual attribute accounts. The invention also illustrates omnicompetent value structures within and between one or more membership accounts using currency denominations of, for example, money, airline miles, reward points, security credentials, real and virtual characteristics, and any combination thereof. The invention is designed for use by individuals, entities, and automated agents such as, for example, consumers, merchants, computerized processors, and any combination of parties conducting membership and value transactions employing network technologies such as electronic, radio frequency, optical, Internet, or any manual transfer methodologies.

2. Description of the Prior Art

If a consumer wanted to subscribe to twenty different merchant loyalty programs (e.g., CVS Corporation's ExtraCare, Southwest Airlines' Rapid Rewards, Morgan Stanley Company's Discover Cashback Bonus/all trademarks and company names are used for referential purposes and are the property of their respective owners), they would need to: access twenty different locations; complete twenty different membership applications; establish and maintain twenty different accounts at each merchant's data processing location; be mindful of twenty different value trusts of various currency denominations (e.g., ExtraBucks, airline miles, money); and, be subject to twenty different avenues of full or partial identity theft. The diverse merchant application standards, irregular information formats, and distributed data storage of membership accounts along with any complementary value trusts embody not only inefficient methods but also incompetent processing structures.

Membership accounts are generally offered using manual and automated means, with automated event processes possibly involving digitized personal profiles, machine-readable privacy policies, and automated data exchanges. While some membership application methods exist that assist with pre-populating electronic forms with personal information, such applications are constrained, for example, in their ability to accommodate priority rankings, assimilate non-standard data tags, and dynamically integrate new data options. In addition, current membership subscription techniques endorse the creation of an applicant's information record within every issuer's membership data store. Once created, membership accounts may incorporate a value trust designed to account for currency denominations including, for example, money or reward points. Similar to the membership account, a value trust currently must exist within every issuer's membership data store. If an applicant has more than one membership account, the current practice of one-member-multiple-accounts is burdensome since there is a lack of centralized account management as well as an inability to consolidate value trust currencies. While account aggregation services exist (e.g., Yodlee, Inc.) they are limited to accessing existing membership data within every issuer's membership data store according to the individual methodologies of each location.

Marketplace participants (e.g., consumers, merchants) are presently limited in their means to conveniently initiate and manage multiple membership accounts, for example, shopper loyalty program accounts. This is due in part to a difficult discovery and subscription process, as well as a non-existent or constricted ability for a ratified member to centrally manage their merchant-based value trusts. At the present time, there are five general stages involved with membership accounts: 1) issuer definition of program requirements and features; 2) publication of the program by the issuer and discovery by an interested party; 3) the provision of information by an applicant sufficient to satisfy a request for information by the issuer; 4) the evaluation of an applicant's information with reference to the issuer's compliance requirements to produce a decision; and, 5) announcement of a disposition to the concerned parties.

Membership Program Design

Currently, an issuer interested in offering a membership account must first define the scope of information that will be requested from an applicant and the features that will be offered to a subscriber. Application information may consist of, for example, a first name, last name, address, gender, date of birth, and e-mail address. If a printed form is being designed, the title of a requested information element (e.g., First Name) may be displayed in a box which provides space for the applicant's written data entry. If an electronic form is designed, programming code will display a data entry title and provide an entry field on a display with further programming code associating an applicant's data entry with the appropriate membership database attribute field. The related programming code would need to adopt and adhere to established standards and data tagging if the application form expected to properly incorporate data that may be available from a digitized personal information profile (e.g., Microsoft's Vcard script: navigator. userProfile. addReadRequest(“Vcard. FirstName”);). All such programming code is readily known by one skilled in the practice of computer programming.

Personal Information Profiles

There are existing applications that provide a person with the ability to create a digitized profile containing personal information (e.g., Microsoft Corporation's Profile Assistant included with Microsoft Internet Explorer) and share such information when a Web site requests personal data from a visitor for application forms or other transactions.

For example, a data owner can use Profile Assistant to specify and record personal registration and demographic information in a profile. Internet Explorer automatically sends this information to Web sites that require it. This saves the data owner from having to type the same information every time they visit a new Web site. This information cannot be viewed on the data owner's computer or shared with others without the data owner's permission.

To share registration and demographic information with Web sites that use Profile Assistant, the data owner must visit the Web site and navigate to the forms page that collects personal registration and demographic information. If the data owner is prompted, they need to allow a data transmission to enable the Web site to collect the data owner's information.

Profile Assistant information is stored securely in protected storage on the data owner's computer. Web servers can request this information, but it is shared only if the data owner gives their consent in a Profile Assistant Confirmation dialog box. There is no incentive mechanism involved to inspire the data owner to release this information. This dialog box is required and it is not possible for a Web site to access this information without the data owner's permission. Once permission is given, the information is transmitted to the Web site where a copy of the personal registration and demographic information is stored on a remote computer server.

Such data profile applications provide only static classifications of an applicant's personal data, they are void of features prioritizing an issuer's data compliance requirements and an applicant's precondition priorities, they do not provide incentive mechanisms or graduated promotional levels of information requests and submissions, they do not record a history of who requested the data along with the information provided and withheld, and they do not communicate profile updates (e.g., change of residential address) which may occur from time-to-time to remote computer servers that have prior copies of registration and demographic information to name some of the limitations of the prior art.

Automated Privacy Policies

Profile Assistant information is considered private within the constraints of the privacy guidelines defined by the Platform for Privacy Preferences Project (P3P) architecture. P3P is a World Wide Web Consortium (W3C) project.

Many company's websites consist of several different sections, each of which may collect information differently, or not at all. Each different section will likely have a privacy policy that is slightly different from the policies of other parts of a Web site. When creating a P3P policy, a designer can choose to have one general P3P policy that attempts to describe all of the various data collecting components of the site.

A site's P3P policies present a snapshot summary of how the site collects, handles, and uses personal information about its visitors. P3P-enabled Web browsers and other P3P applications will read and understand this snapshot information automatically, compare it to the Web user's own set of privacy preferences, and inform the user when these preferences do not match the practices of the Web site he or she is visiting.

The sole intent of P3P applications is strictly the notification of privacy policies and the acknowledgement by users of how their data may be collected and employed. The current operations either allow a user to opt-in or opt-out but do not provide options to employ opt-in incentives according to a graduated priority data schema. In terms of registration and demographic information data elements, the user is either all-in or all-out with no middle ground which points to another deficiency with the prior art. Users should be allowed to surrender personal information in exchange for premiums which may subordinate the original data release decision which was based solely on privacy concerns.

Membership Application Process

In one possible situation, a consumer conducting business with a merchant may discover that the merchant offers a discount or incentive for a purchase if the consumer belongs to the merchant's loyalty program. Typically, a consumer may enroll in a merchant's loyalty program either by manually completing a physical form or by completing an electronic version of the membership application form, for example, by using an Internet Web site form.

At the beginning of the membership application process, the merchant requests compulsory information and possibly optional information from the applicant. This request for information may be accompanied by human- and machine-readable privacy policy formats which explain how the applicant's information may be used by the merchant. During a manual application event, the applicant may review the privacy policy communications and mentally determine if they are within acceptable limits. During a computerized application event, the privacy policy communications automate privacy decision-making based on the stipulated policy practices so that users need not read the privacy policies for every membership application they encounter. While assisting in the determination of privacy boundaries and acceptable data use, such privacy policy communications provide no connection between the merchant's data compliance needs and possible incentive structures and an applicant's data precondition priorities and valuation of their personal data.

After entering personal and demographic information to complete the application form, the consumer would submit the form by any appropriate means (e.g., mailing a paper form to the merchant or a processing agent, clicking an on-screen button for an electronic version) thus causing it to be submitted by appropriate methods for a membership compliance evaluation. On receipt of the application data, the merchant or their agent will determine if the consumer has provided sufficient information to qualify for the ratification of a membership account in the merchant's loyalty program. This membership evaluation is separate from issues related to privacy policies since privacy policies affect data that may be submitted, while evaluations deal with data that has been submitted. After determining the sufficiency, or lack thereof, the consumer is notified of their application's disposition with possibilities including: 1) the creation and availability of a unique or generic object substantiating the ratification of a membership account (e.g., an individual database record, a group access code) which may confer, for example, an account identification moniker and the issuance of a physical device such as a membership card, token, or frequency; 2) a reply appealing for the completion of information that was requested by the merchant for proper membership evaluation but not supplied by the consumer; or, 3) a reply indicating the denial of the application based on non-compliance with membership requirements.

In the first situation stated above regarding the issuance of an account, the consumer is recognized by the merchant as a loyalty program member upon presentation of suitable identifying credentials and may receive special features, rewards, discounts, and sundry opportunities as offered by the merchant to authenticated program members. Such features, rewards, discounts, and sundry opportunities shall be referred to as premiums as an aggregating term for convenience, but such convenient term is not intended to limit the universe of possible objects and denominations that may be employed in a transaction between two or more parties.

In the second situation stated above regarding an incomplete application, the consumer is allowed to either provide additional information or discard the application by means of their action or inaction. The merchant merely requests that inappropriate or missing application entries be provided without any incentive action on the part of the merchant to obtain withheld or incomplete information. The submission of additional information will likely result in an outcome depicted in either the first or third situations as listed above, but also may result in the consumer being directed to a recurrence of the second situation, or perhaps an alternative application processing avenue.

In the third situation stated above regarding the denial of an application, the consumer is notified of the rejection decision and the merchant may retain the consumer's registration and demographic information. Presently, there is no method available for the merchant to automatically monitor changes in a consumer's demographic information concerning the data elements which caused the applicant's denial in order to incorporate the most current registration and demographic information adjustments and re-evaluate a previously filed application in order to potentially generate a membership account. For example, a person who previously filed an application with a professional association and was denied a membership account based on an inadequate certification will not be automatically reconsidered if they eventually achieve an appropriate certification. While there are methods currently in operation that allow companies to monitor consumer credit scores (e.g., Experian, TransUnion, Equifax), such monitoring activities merely allow for new membership invitations to be sent to consumers if they are deemed likely prospects. Current membership processes are not capable of engaging in a holistic review of all registration and demographic information and being able to undertake the amendment of previously supplied and denied consumer application data which may exist in a company's application files.

Prior Art Examples and Limitations

Various proposals have been made to enhance membership application systems to provide benefits to parties such as consumers, merchants, and automated agents. However, no proposals to date have enabled membership account issuers and applicants to interact by way of an interoperable account junction to negotiate dynamic information exchanges.

Referring now to FIG. 2 and FIG. 3, therein depicted are representations of two conventional screen displays showing an electronic application form for a consumer loyalty program (e.g., XxtraKare) and a credit card bonus program (e.g., AExpress). It can thus be seen how merchants create different electronic screen displays to suit their particular preferences and information requirements. In addition to different screen displays, the issuers host their electronic applications at different Web site locations (e.g., www.cvs.com, www.americanexpress.com) which are connected to their individual membership databases.

Upon ratification of a membership account, the applicant will have the ability to accrue premiums in an issuer provided value trust and such value trust will be managed by the issuer according to the terms of the program application. For example, a cash back premium may provide for the issuer of such loyalty program currency to accrue a percentage of funds due a member in an account and transfer such currency balance to the member upon a member request, at predetermined times, or upon attaining a certain minimum balance in the account.

The prior art is deficient in that it is based on each membership account issuer setting program features and creating application information requirements instead of configuring its membership program to accommodate an applicant's data precondition priorities. To improve the prior art, the present invention builds a system that changes static membership features configured by the issuer into dynamic membership features negotiated by the applicant.

The prior art is further deficient since any membership account and complementary value trust, conjoined with a ratified membership account, is subject to the access control of the issuer. The present invention provides an interoperable account junction to link issuer account program identifiers with applicant data stores to normalize data and provide members with expanded access and management operations. A further enhancement allows the member to select the depository destination of any complementary value trust account. Such value trust enhancements mitigate the sole authority of the issuer to control the value trust and places the primary authority of the value trust with the member.

As membership activities involving the request and provision of registration and demographic information expand, the prior art is not aligned with providing effective solutions to assess and integrate an issuer's information compliance requirements and the applicant's precondition priorities. Eliminating data element conflicts, executing negotiated data exchanges, dynamically configuring feature sets, and implementing real-time data updates in membership ratification and management processes will provide benefits to users and society. Likewise, the growing use of membership value trusts with their varied currency denominations is providing more wealth to members, but such wealth is difficult to coordinate due to its distributed and diverse nature. Allowing members more direct control of such value trusts will increase the convenience and economic wealth of participants throughout the global economy.

### REFERENCE PUBLICATIONS

Using the Profile Assistant, Microsoft Corporation, Referenced 21 Jun. 2006 from http://msdn. microsoft.com/library/default.asp?url=/workshop/management/profile/profile_assista nt.asp
Platform for Privacy Preferences (P3P) Project, World Wide Web Consortium (W3C), Referenced 21 Jun. 2006 from http://www.w3.org/P3P/
Creating a CVS ExtraCare Account, CVS Corporation, Referenced 22 Jun. 2006 from https://www.cvs.com/CVSApp/cvs/gateway/registerextracare?LOGINMSG=XTRACAREMSG
Get One from American Express, American Express Company, Referenced 22 Jun. 2006 from https://www201.americanexpress.com/cards/Applyfservlet?csi=51/23000/b/10/1736832841/173 165431719/0/n
Account Aggregation and Integration, Yodlee, Inc., Referenced 22 Jun. 2006 from http://corporate.yodlee.com/technology/platform_overview.html

### SUMMARY OF THE INVENTION

In view of the deficiencies of the prior art discussed before, the present invention is advantageous in that it provides a dynamically integrated data exchange and management system for membership accounts and related value trusts.

In addition, the present invention functions with any membership publishing and provisioning system. It exposes and joins issuer and applicant information structures that enable the present invention to evaluate and determine linkages from an extensive catalog of linked data elements. The ongoing linkage of membership accounts with applicant data will provide issuers with continuously up-to-date member information (e.g., mailing address) and the ability to obtain newly created applicant data elements, and also allow members to enjoy simplified discovery and negotiation of issuer-sponsored opportunities.

The present invention allows an applicant's precondition priorities to establish the features provided by a membership account instead of statically accepting an issuer's pre-defined offer of features. The present invention exceeds the limits of privacy policies by engaging in negotiated exchanges attempting to obtain value for the release of data. The invention may also contrast and compare proposed membership features and engage in competitive negotiations to stimulate alternative recommendations, cooperation, and solutions.

Furthermore, the present invention responds to environmental changes with or without human intervention; and may evolve through selecting advantageous and prioritized results from fixed patterns and random mutations all of which provide benefit to users.

Another advantage of the present invention is that it offers direct access to and control of account management operations. The present invention integrates with conventional payment, settlement, and incentive systems as well as any type of membership account.

Operational Performance

The present invention provides a system to tag, classify, input and store an issuer's membership account program structure and also tag, classify, input and store an applicant's registration and demographic information. Upon an applicant initiating a process to obtain a membership account, the invention correlates an issuer's account program structure with available information from an applicant's data store. A dynamic configuration of issuer features may ensue based on the information supplied by an applicant. Alternative and cooperative membership structures may be introduced and employed in a final or variable solution. Complementary value trusts, when offered with membership accounts, have the ability to be designated by the applicant and used in addition to, and as replacements for, standard issuer value trusts. Such value trusts may encompass variations in currency denominations as requested by an applicant. Membership accounts and value trusts will provide access and management operations based on the member having primary control and the issuer occupying a subordinated role in terms of access and management activities.

The present invention creates an interoperable account junction by constructing a data dictionary and providing access to both issuers and applicants. For reference purposes, the present invention will be referred to as a Junction Account to distinguish it from an issuer's master profile record and an applicant's master profile record each containing operational information concerning the subscriber (e.g., name, address, service subscription rate). A Junction Account will contain information from a master profile record as well as additional application specific information including, for example, feature levels, data classifications, and such information and algorithms as may assist with the construction and operations of a Junction Account in the performance of this invention. There may be unique characteristics to issuer and applicant Junction Accounts. For example, an applicant's Junction Account will contain a reference to all submitted membership applications whether approved, disapproved, or abandoned.

A program issuer will create and store a membership account structure like the one shown in FIG. 4 in their Junction Account. The issuer will define a unique MEMBERSHIP ACCOUNT ID to identify a membership account. The membership account will be associated with the issuer's unique ISSUER ACCOUNT ID. A data tag as defined in the invention's interoperable account junction data dictionary will be selected by the issuer in accordance with their membership requirements. The issuer will designate an ENTRY STANDARD indicating if, for example, the information being requested is Not Applicable, Required, or Optional. In conjunction with the ENTRY STANDARD, an issuer may use the FEATURES FIRST TIER to designate the membership features that will be provided by an applicant's provision of the data requested. For example, a tier designation of “A” may provide for a basic feature set to be incorporated in the membership account (e.g., a one percent cash back reward). The issuer may also select to offer extended features to induce the provision of the requested data by designating a FEATURES SECOND TIER classification of “B” (e.g., a two percent cash back reward). An unlimited number of feature tiers may be used by the issuer to accommodate their needs. The feature tiers may be presented on the original display of an application form, or they may be displayed on successive displays of the application form after the issuer reviews the data supplied by an applicant.

Applicants create and store a personal profile account structure like the one shown in FIG. 5 in their Junction Account. A program applicant will populate their Junction Account with registration, demographic, and precondition priority information. A unique APPLICANT ACCOUNT ID is assigned to each applicant's Junction Account. An INFORMATION DATA TAG defines the data dictionary moniker and stores the applicant's information (e.g., FNAME is the first name data element and may contain the name Gregory). Ongoing access to the contents of the INFORMATION DATA TAG are influenced by setting an update option in PERMIT UPDATES (e.g., automatically communicate updated information to remote data locations, manually authorize data updates to any data location). If a new INFORMATION DATA TAG is added to the data dictionary in the future, an issuer may request it and the update status may provide it according to provision levels should an applicant enter such information in their Junction Account. When an issuer's membership application requests the contents of a specific INFORMATION DATA TAG (e.g., FNAME), the PROVISION FIRST LEVEL setting will guide the release of applicant information. A PROVISION FIRST LEVEL setting of, for example, “Supply” will provide the applicant's data for the particular data tag on the first encounter with an application form. The PROVISION FIRST LEVEL may also include, for example, settings of “Restricted” (data dependent on conditional factors), “Withhold” (data never released), and “Negotiate” (query issuer's FEATURES FIRST TIER setting, or any additional tier settings, to determine if there are incentives for providing this data, otherwise restrict applicant data unless required for membership). The PROVISION SECOND LEVEL and such further level settings operate by the same methods as the PROVISION FIRST LEVEL. The settings indicated throughout are not intended to limit the range of possible options.

Once issuers and applicants have completed their respective Junction Account entries as necessary with their intended use, such membership programs and personal profiles may enter the marketplace. Upon discovering that, for example, a merchant (the issuer) provides a shopper loyalty reward program, an applicant may access the present invention by means of an Internet connection and initiate a membership application. The membership application may be hosted on the issuer's Web site and a connection made to populate the on-screen form with Junction Account data elements, or the membership application may be hosted on the present invention's Web site with similar actions as examples of operating situations. An automatic process will compare the issuer's DATA TAG IDENTIFIER requirements and ENTRY DEMAND settings to the applicant's PROVISION FIRST LEVEL and any additional provision level settings to determine what information is requested and what information will be supplied. If an applicant's PROVISION FIRST LEVEL has a setting other than “Supply,” then a series of negotiation exchanges will occur to obtain better membership features from the issuer or determine if information may be withheld without withdrawing the application. If the issuer provides additional membership features and incentives for obtaining certain information (e.g., applicant's grocery purchase history), and the applicant has set an option to negotiate for better features, then the applicant may accept an issuer-centric currency denomination or specify a preferred currency denomination for the issuer to bestow for the guarded information. Upon the determination of information to be supplied by the applicant to the issuer, such information may be guided by preferences as to where the information will be stored. The applicant may request that their data be maintained in data depository locations of the applicant's designation (DATA TRUST LOCATION). For example, a DATA TRUST LOCATION may indicate “Issuer” which would allow the data in a ratified membership account to be stored at an issuer's data store location. Another example could have a DATA TRUST LOCATION specifying a value trust account maintained at a financial institution for the maintenance of registration information and deposit of earned premiums (e.g., airline miles). Each applicant data element would have the option of designating a data store location for each data element contained in a ratified member account. The issuer would associate such data store locations with the ratified member's account and maintain information in such locations as designated. Such data store locations will provide omnicompetent value structures that accommodate any single or multiple data elements including such items as, for example, premiums with the further ability to conduct data management (e.g., add, modify, delete, transmit, receive) and processing operations (e.g., addition, multiplication, division, conversion) involving data elements.

Present Invention Highlights

It is an advantage of the present invention that a data dictionary provides issuers and applicants with standardized data tags specific to membership applications. Such standardized data tags provide a further advantage such that issuers and applicants may engage in the comparison and provision of similar data elements and undertake negotiations for the data. The present invention's negotiated operating structure provides another advantage such that program features may be negotiated on an individual basis. The present invention also is advantageous in that it provides applicants with the ability to select data and value trust locations allowing unprecedented control of registration and demographic information. Another advantage of the present invention is that it normalizes data between and among all parties such that there is only one central source of information thus eliminating redundant and out-of-date information being used in membership accounts. Yet another advantage of the present invention is that premiums may be directed to applicant-designated value trusts and consist of preferred currency denominations. Another advantage is that issuers will have the ability to discover information available from an applicant and provide incentives to obtain such information that may not be immediately provided in the application form. A further advantage of the present invention is that applicants will have the ability to negotiate for enhanced features before providing guarded information that may be requested by the issuer. Overall, such advantages provide a tiered-membership program structure in which issuers and applicants determine the economic value of each data element and respond as may generate the best alternatives and features for each participant.

Application and Use of Benefits

It is an object of the present invention to allow issuers to design and host application forms using standardized data tags on their internal servers and systems. Such internal application forms may reference Junction Account data elements and store them in a whole format (e.g., a first name locally stored consisting of “Gregory”) on an internal data store. In addition, such internal application forms may reference Junction Account data elements and store them in a referenced format (e.g., a first name remotely stored consisting of the contents of the Junction Account data element “APP-101-FNAME”) on an internal data store with access to such referenced information on an external data store. An issuer may specify that both methods be employed in the operation of their membership application form.

It is a further object of the present invention to allow issuers to design and host application forms using standardized data tags on the invention's servers and systems. Such application forms may transmit applicant data (e.g., whole format, referenced format, both formats) to a data store of the issuer's selection.

It is yet another object of the present invention that premiums be directed to value trusts as specified by issuers and applicants according to participant requests and requirements.

### EXAMPLE APPLICATION OF THE PRESENT INVENTION

In order to clarify various example applications of the present invention, the following scenarios demonstrate potential operations.

### Application Example 1

An issuer creates a Junction Account with a related membership application to be hosted on their Web site server. The membership application requires the entry of a first name and last name and optionally requests the applicant's date of birth. The information is to be transmitted from an applicant's Junction Account to the issuer's data store by reference to the data elements. Provisions are offered to obtain an applicant's date of birth if it is not immediately provided by enhancing the features of the membership account.

An applicant creates a Junction Account with their registration and demographics information. The applicant discovers and initiates an issuer's membership application and uses their Junction Account to process the application's information requests. The applicant's instructions cause the present invention to negotiate for enhanced features before supplying the guarded data element “date of birth” information. Upon achieving a negotiated settlement of information to be provided and program features to be received, the present invention's methods commits the applicant data to the issuer's data store.

Since the issuer requested data elements be provided in referenced format, a unique identifier to the applicant's first name, last name, and date of birth information is sent to the issuer. The issuer's system will record the reference identifiers and be allowed access to retrieve the applicant's information in whole format. The use of the referenced format will allow the issuer always to have access to the most up-to-date applicant information. Should a new data tag be implemented at a future time, such new applicant information may be offered to the issuer dependent upon the settings which the applicant places on the data elements.

If a value trust was established for premiums, any earned premiums will be deposited in the designated account as maintained by either the issuer or as maintained by the applicant or their agent.

In addition to the advantages and capabilities provided to the issuer, the applicant is able to centralize the management of all membership accounts by maintaining their Junction Account. Presently, if an applicant changes their mailing address they would need to change their mailing address at every membership data store location to which they have subscribed. Since issuers may request information by reference identifier, all applicant modifications to their registration and demographic information will be automatically and immediately provided to any issuers with access to the data elements. Another enhancement for the applicant is that by designating a specified destination value trust for premium deposits and redemptions, the applicant will have the ability to access and manage the account without the need to transverse through the issuer's control or access structures. This is valuable in that any currency denomination may be contained in an omnicompetent value trust and such value trust is more secure against potential issuer bankruptcies and other operational anomalies.

### BRIEF DESCRIPTION OF THE DRAWINGS

The present invention is described in detail below with reference to the following drawing figures of which:

FIG. 1 is a block diagram of a system for creating and maintaining issuer and applicant data stores along with operations involving value stores and related functions within a transaction processing system;

FIG. 2 is a conventional screen display showing an electronic application form for a consumer loyalty program;

FIG. 3 is a conventional screen display showing an electronic application form for a credit card bonus program;

FIG. 4 is a diagram depicting an issuer's membership account structure within a database;

FIG. 5 is a diagram depicting an applicant's profile account structure within a database.

### DETAILED DESCRIPTION OF THE PREFERRED EMBODIMENTS

The present invention is described in detail below with regard to the drawing figures briefly described above.

Various implementations of the present invention consist of: a method to enable an issuer to define membership account information to be requested, features provided, access channels, and destination data stores along with all appropriate maintenance functions; a method to enable an applicant to store registration and demographic information, initiate an application for a membership account, direct such registration and demographic information as stored to an application form, negotiate for membership features, specify data element preferences, and indicate the destination data and value stores and associated locations to be used along with all appropriate maintenance functions; and, a method that permits a value trust to be controlled by an applicant and consist of various currency denominations irrespective of issuer premiums.

All embodiments may utilize a means for a user to view and select data elements and associated linkages, and to transmit appropriate actions and transaction information to related parties to settle a requested transaction. In addition, all embodiments may be performed automatically without user intervention to conduct, select, and transmit appropriate actions and transaction information to related parties to settle a requested transaction.

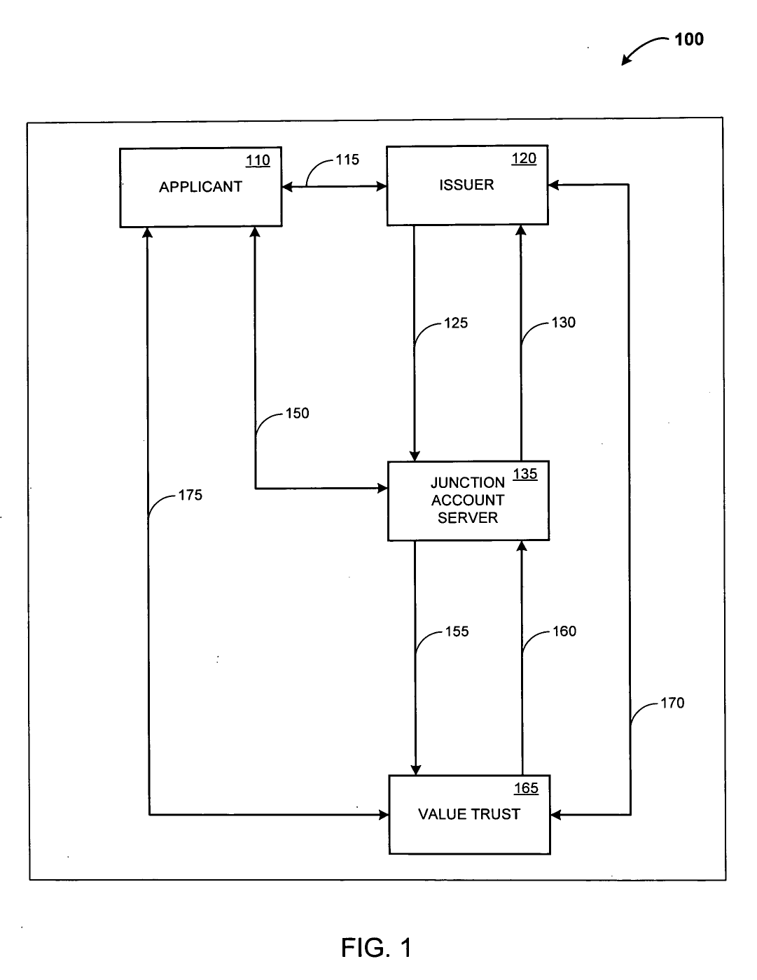

Referring now to FIG. 1, therein depicted is a block diagram of a system for establishing and executing membership functions within a transaction processing system, such as, for example, within a shopper loyalty reward system and a Junction Account server processing system, that includes such elements as structured data, application form designs, accounts, transactions, membership form structures, and preferences and settings. System 100 is configured to allow applicants. (e.g., consumers), issuers (e.g., merchants), and value trust locations to engage in the provisioning of membership account applications and associated data request and data supply system functions.

Regardless of the physical devices and mediums that are chosen for implementation, system 100 and the present invention certainly contemplate the use of any communications device and medium that will allow access to the Junction Account Server for appropriate execution to affect a particular transaction and related accounts.

System 100 allows the use of data request and data supply functions that permit an issuer to create a membership account program and applicants to apply for and configure such membership program and related details.

From a high level, system 100 operates to allow an applicant 110 (e.g., a consumer having created an account with the present invention) to interact with an issuer 120 (e.g., a merchant having created an account with the present invention and offering a membership program); a Junction Account server 135; and, value trust data stores 165 in ways not heretofore provided. Applicant 110 and issuer 120 exchange information via link 115. Merchant 120 and Junction Account server 135 exchange information with each other via links 125 and 130, respectively.

Link 115 allows applicant 110 to exchange transaction related information, such as a data element delivered as a reference identifier, with merchant 120. Once received in the course of a transaction (e.g., a shopper loyalty program application), merchant 120 can then re-transmit such transaction information to Junction Account server 135 for appropriate processing. After Junction Account server 135 receives such information, Junction Account server can process the transaction request from merchant 120 after reviewing registration and demographic data as maintained by applicant 110 on the Junction Account server to determine and select appropriate data elements. Junction Account server 135 continues to process the transaction request in accordance with the issuer's requirements and the applicant's precondition priorities.

Links 115, 125, 130, 155, 160, and 170 are intended to be comprised of and utilize conventional data communication processing systems and data links, as well as any state-of-the-art systems. For example, link 115 may involve the use of personal computers connected to the Internet. Additionally, other communications mediums such as dedicated telephony call centers having automated and human operations could be setup to handle the communication of transaction related information between applicant 110, issuer 120, Junction Account server 135, and value trusts 165. Personal, ultra mobile, and wireless connected computing devices are certainly envisioned for the deployment of the present invention. The use of such alternative communication and computing vehicles will be readily appreciated by those skilled in the art.

In the context of the present invention, functions may be specified either by their specific and underlying computer programmed and mathematical operations (i.e., the detailed instructions executed or run to effectuate the intended task) or by labels referred to herein as “reference identifiers.” Such processing and logic will be readily apparent to those skilled in the art of computer programming.

Regardless of the communications mediums and encoding methods that are chosen for implementation, system 100 and the present invention certainly contemplate the use of any communications medium and identification methodology that will allow a function or function identifier to be transmitted, received, and interpreted by Junction Account server processing systems and users that will enable recognition and execution of the appropriate functions in order to affect transactions and related accounts in a certain way.

The processing that occurs to allow the negotiation of enhanced program features involves iterative and interactive type processing and will be readily appreciated by those skilled in the art of computer programming after reviewing the remainder of this section.

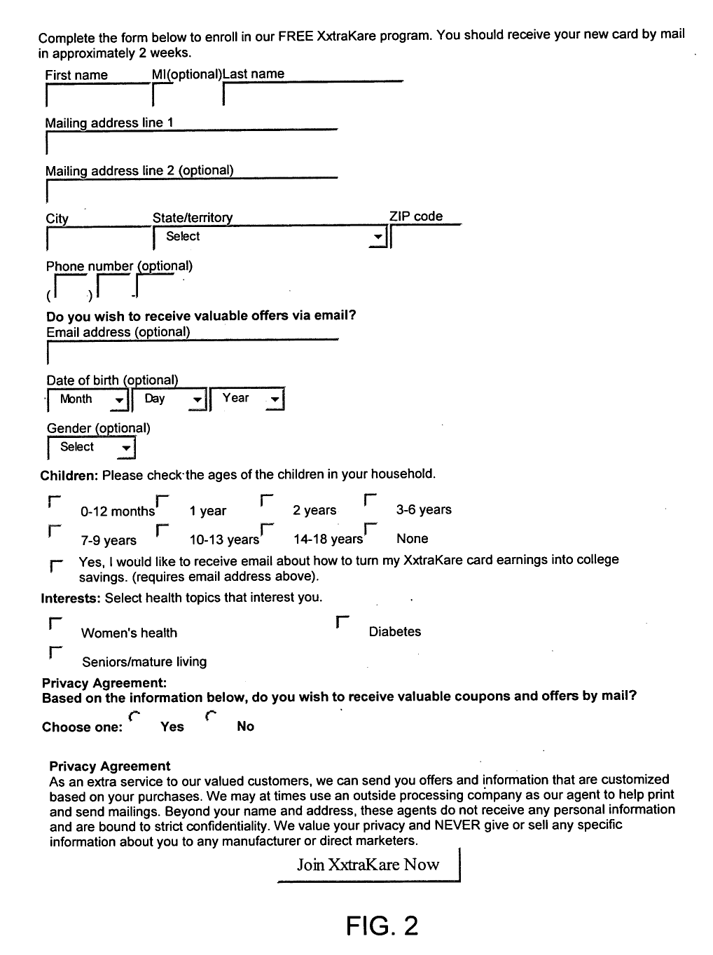

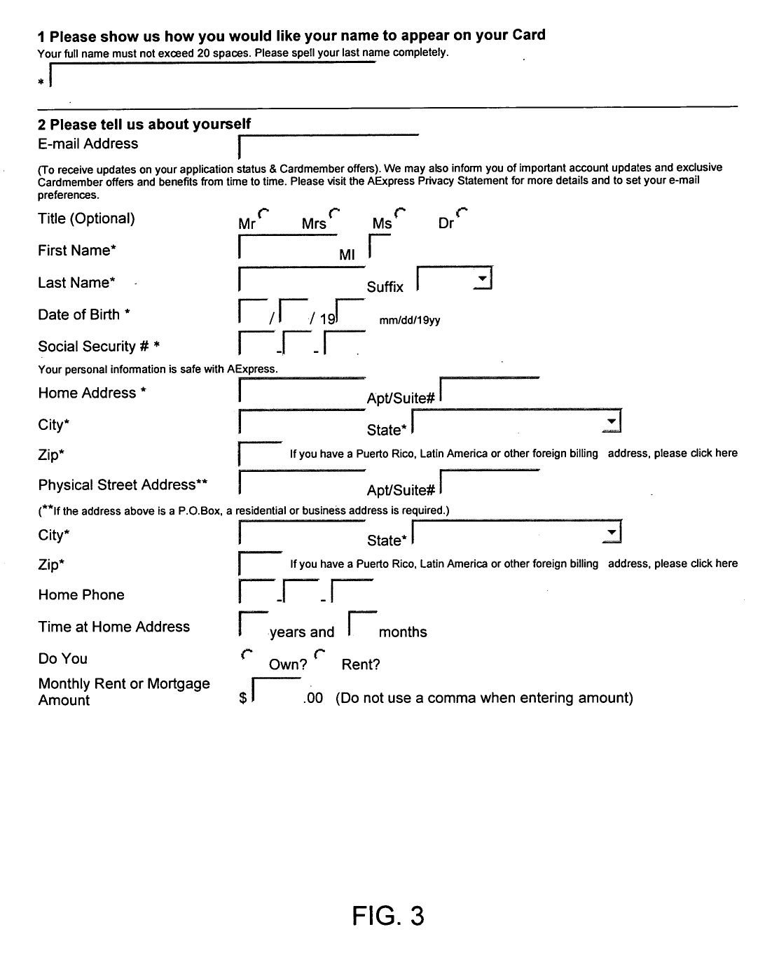

Referring now to FIG. 2 and FIG. 3, therein depicted are prior art representations of various issuer's application forms. It can be readily appreciated the multitude of differences between the information requested and the format of data entry.

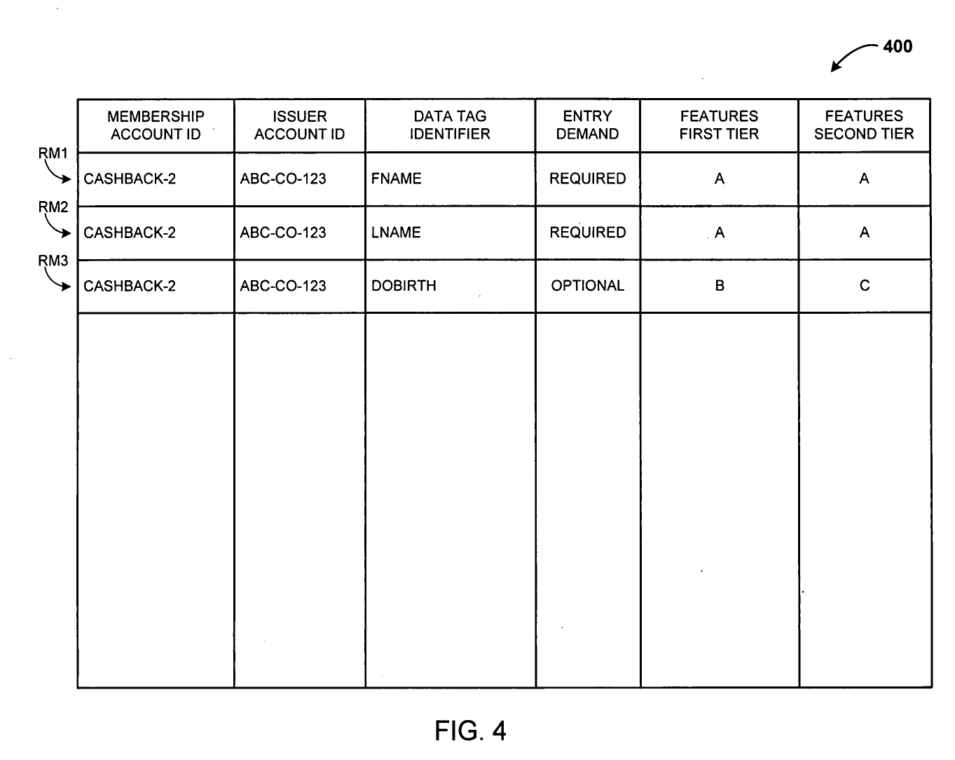

Referring now to FIG. 4, therein depicted is a diagram of an issuer account database table 400 which is maintained at a Junction Account server as shown in FIG. 1. In particular, issuer account database table 400 (hereinafter referred to as “table 400”) comprises a database management system table that is preferably used in a relational arrangement whereby table 400 is related to other tables in the particular database management system by way of common columns or table fields. In any case, table 400 is maintained in an electronic data storage device as is readily understood to those skilled in the art of computer database systems. Table 400 has a field structure including fields (from table left to right) MEMBERSHIP ACCOUNT ID, ISSUER ACCOUNT ID, DATA TAG IDENTIFIER, ENTRY DEMAND, FEATURES FIRST TIER, and FEATURES SECOND TIER. Of course, table 400's field or column structure is simplified here for purposes of brevity; in actual implementation, many more fields may be used to record other issuer and membership program information and to record system parameters related to particular issuer records in the same or different database table. The fields form the columns of table 400 and the data records form the rows of table 400. The layout of table 400, including its appearance in FIG. 4, will be readily appreciated by those skilled in the art of database management system design and implementation. It should be noted that the columns and their apparent arrangement in table 400 are merely exemplary to enable one skilled in the art to make and use the present invention; no inferences should be drawn that the table structure (logically or physically) as shown is intended to limit the structure that is ultimately implemented.

The column identified with the label MEMBERSHIP ACCOUNT ID stores data representing the membership program identification codes assigned to the respective Junction Account issuer. The ISSUER ACCOUNT ID stores data representing the unique reference identifier of an issuer's master profile record. The DATA TAG IDENTIFIER stores information related to the data element tag used in an applicant's Junction Account database record for cross-reference compatibility. The ENTRY DEMAND stores information indicating if the DATA TAG IDENTIFIER specified for use is an optional, mandatory, or negotiated data entry being requested from the applicant. The FEATURES FIRST TIER stores information specifying the features the issuer is willing to provide to receive the requested DATA TAG IDENTIFIER information from an applicant. The FEATURES SECOND TIER stores information specifying the features the issuer is willing to provide to receive the requested DATA TAG IDENTIFIER information from an applicant if the applicant did not provide it on a previous tiered request. The number of tiers is unlimited and only conditioned on the issuer's desires.

It should be understood that the present invention may accept information for inputting into table 400, as well as the other tables mentioned below, by any means or methods such as, for example, information on paper forms transported by the United States Postal Service to a central data entry site, information conveyed by facsimile machines to receiving machines, electronic presentation and entry systems incorporating the Internet or any electronic communication modalities, information conveyed by voice response units or human service representatives, or data and information accessible by referencing services exposed by computer systems in a computer system-to-system arrangement using, for example, the extensible mark-up language used in computer programming.

In terms of the data and information stored in table 400, three records (i.e., rows) are shown. A first record RM1 has been entered into the database management system and into table 400 to store data related to a membership program titled CASHBACK-2 which is associated with issuer ABC-CO-123. This record indicates that the issuer is requesting the entry of a first name (e.g., FNAME) data element from every applicant and that such entry is required for the membership application to be processed. An applicant will be provided with the membership features associated with the Feature A level (e.g., basic airline mile rewards). A second record RM2 has been entered into the database management system and into table 400 to store data related to a membership program titled CASHBACK-2 which is associated with issuer ABC-CO-123. This record indicates that the issuer is requesting the entry of a last name (e.g., LNAME) data element from every applicant and that such entry is required for the membership application to be processed. An applicant will be provided with the membership features associated with the Feature A level (e.g., basic airline mile rewards). A third record RM3 has been entered into the database management system and into table 400 to store data related to a membership program titled CASHBACK-2 which is associated with issuer ABC-CO-123. This record indicates that the issuer is requesting the entry of a date of birth (e.g., DOBIRTH) data element from every applicant and that such entry is optional for the membership application to be processed but includes the incentive to elevate the membership level. If an applicant provides such information on a first request, the applicant will be elevated to receiving the membership features associated with the Feature B level (e.g., double airline mile rewards). If an applicant does not provide such information on a first request, the applicant may be requested for the information a second time with a higher incentive offering to elevate the membership features to the Feature C level (e.g., triple airline mile rewards). Upon successive applicant refusals, the membership form will offer successively elevated membership features until all such elevated feature tiers as defined by the issuer are exhausted.

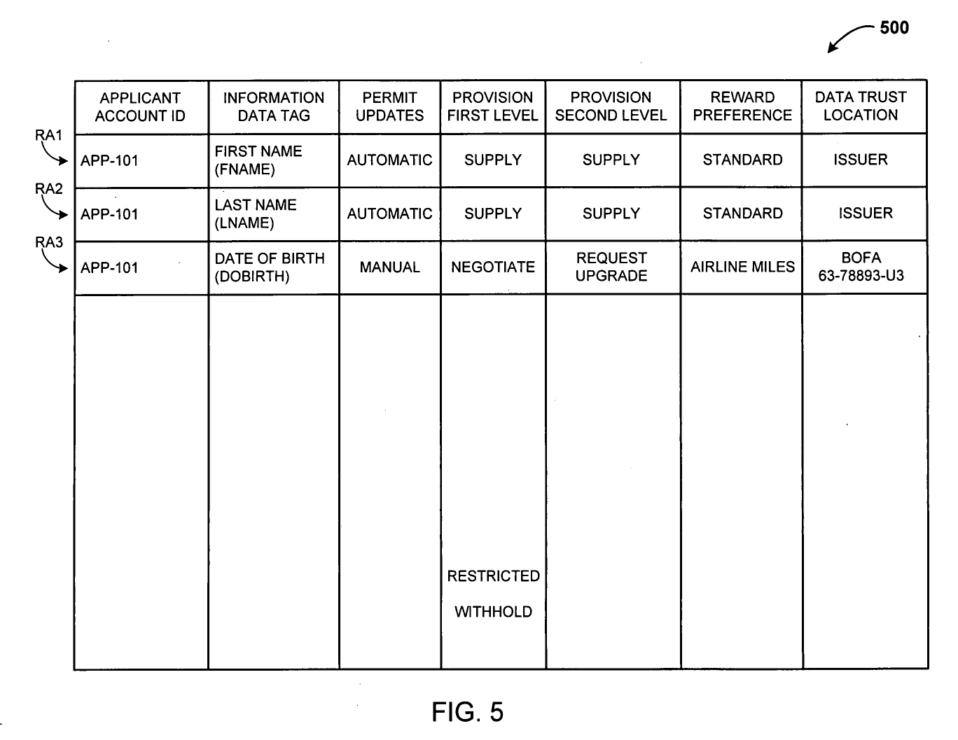

Referring now to FIG. 5, therein depicted is a diagram of an applicant account database table 500 which is maintained at a Junction Account server as shown in FIG. 1. In particular, applicant account database table 500 (hereinafter referred to as “table 500”) comprises a database management system table that is preferably used in a relational arrangement whereby table 500 is related to other tables in the particular database management system by way of common columns or table fields. In any case, table 500 is maintained in an electronic data storage device as is readily understood to those skilled in the art of computer database systems. Table 500 has a field structure including fields (from table left to right) APPLICANT ACCOUNT ID, INFORMATION DATA TAG, PERMIT UPDATES, PROVISION FIRST LEVEL, PROVISION SECOND LEVEL, REWARD PREFERENCE, and DATA TRUST LOCATION. Of course, table 500's field or column structure is simplified here for purposes of brevity; in actual implementation, many more fields may be used to record other applicant information and to record system parameters related to particular applicant records in the same or different database table. The fields form the columns of table 500 and the data records form the rows of table 500. The layout of table 500, including its appearance in FIG. 5, will be readily appreciated by those skilled in the art of database management system design and implementation. It should be noted that the columns and their apparent arrangement in table 500 are merely exemplary to enable one skilled in the art to make and use the present invention; no inferences should be drawn that the table structure (logically or physically) as shown is intended to limit the structure that is ultimately implemented.

The column identified with the label APPLICANT ACCOUNT ID stores data representing the applicant identification code assigned to the respective Junction Account applicant. The INFORMATION DATA TAG stores data representing the applicant's personal, registration, and demographic information as appropriate according to a uniform data tag moniker (e.g., FNAME for first name). The PERMIT UPDATES stores data indicating if the applicant will allow or restrict updated information to be sent to all membership accounts to which the applicant has subscribed. All membership accounts for an applicant will be recorded and linkages to appropriate issuer update processing systems are contained and stored within this present invention in order to accomplish its purposes. The PROVISION FIRST LEVEL stores data indicating if the information contents of the INFORMATION DATA TAG data element will be provided when requested during an initial application request. If a condition of “Supply” is used by the applicant, then such data element information will be supplied to the application form. If a condition of “Negotiate” is used by the applicant, then the present invention will ascertain if the issuer is willing to negotiate enhanced membership features if the information is provided. The PROVISION SECOND LEVEL stores data indicating if the information contents of the INFORMATION DATA TAG data element will be provided when requested during a second application request. If a condition of “Supply” is used by the applicant, then such data element information will be supplied to the application form. If a condition of “Request Upgrade” is used by the applicant, then the present invention will ascertain if the issuer is willing to negotiate and provide enhanced membership features if the information is provided. Upon successive issuer enhancements, the applicant will offer successively elevated membership requests until all such provision tiers as defined by the applicant are exhausted. Upon successful negotiation of enhanced membership features, and incorporation by the issuer to honor an applicant's request for preferred premiums, the applicant may provide REWARD PREFERENCE information that stores information related to the applicant's preferred premiums. The DATA TRUST LOCATION stores data indicating if the applicant requests such supplied information to be located at an issuer data store location (e.g., ISSUER) or at one or more data trust locations (e.g., cash back deposits being made to a bank account).

In terms of the data and information stored in table 500, three records (i.e., rows) are shown. A first record RA1 has been entered into the database management system and into table 500 to store data related to an INFORMATION DATA TAG titled FNAME which is associated with applicant APP-101. This record indicates that the applicant is supplying the entry of a first name (e.g., FNAME) data element for a membership application to be processed. The applicant will allow automatic updates of this information to be sent to the issuer and the applicant will accept the standard membership features when they provide this information. A second record RA2 has been entered into the database management system and into table 500 to store data related to an INFORMATION DATA TAG titled LNAME which is associated with applicant APP-101. This record indicates that the applicant is supplying the entry of a last name (e.g., LNAME) data element for a membership application to be processed. The applicant will allow automatic updates of this information to be sent to the issuer and the applicant will accept the standard membership features when they provide this information. A third record RA3 has been entered into the database management system and into table 500 to store data related to an INFORMATION DATA TAG titled DOBIRTH which is associated with applicant APP-101. This record indicates that the applicant is guarding the entry of a date of birth (e.g., DOBIRTH) data element for a membership application. The applicant will allow manual updates of this information to be sent to the issuer only upon review and authorization. The applicant is willing to negotiate supplying the requested information but only if the issuer provides enhanced membership features. If the issuer accepts the negotiated counteroffer of the applicant, enhanced features and possibly preferred premiums will be issued to the applicant. If the issuer permits the designation of a value trust location, the information related to the applicant's data trust location will be supplied for use in the storage of membership information and value trust currencies.

It is also contemplated that a portable computing device may be synchronized either automatically or on-demand by an applicant with a Junction Account server central system to obtain applicant information for use in a standalone membership application processing situation. For example, the applicant's information may be stored on a radio frequency identification tag capable of storing appropriate information and using it at an application kiosk to make available applicant information and precondition priorities.

While various embodiments of a preferred embodiment have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

Accordingly, having fully described the present invention by way of example with reference to the attached drawing figures, it will be readily appreciated that many changes and modifications may be made in the form and steps thereof and to the invention and to any of the exemplary embodiments shown and described herein without departing from the spirit or scope of the invention which is defined in the appended claims.

What is claimed is:

1. A method for use in the publication, negotiation, and acquisition of membership accounts, said method employing computer means having data storage means and network communications means and comprising the steps of:
(a) a membership program issuer creating an account design stipulating information requirements and membership features based on the delivery of various information by an applicant;
(b) a membership program applicant creating a warehouse of personal and demographic information available to be supplied to an issuer's membership application based on the attainment of certain precondition priorities; and
(c) the selection of value trust locations where membership account data and complementary data structures will reside.

2. The method of claim 1 comprising the further step of an issuer defining a membership program with:
(a) a unique membership program identifier with an associated program description;
(b) a listing of applicant information to be requested according to a data dictionary;
(c) the level of necessity of the applicant information being requested; and
(d) a set of feature tiers that could be offered to an applicant as incentives to submit the requested information as provided by the one or the more than one issuer.

3. The method of claim 1 comprising the further step of an applicant defining:
(a) personal and demographic information according to a data dictionary;
(b) the level to which updates of information will be provided to issuers who have permission to receive personal or demographic information;
(c) the level to which personal and demographic data will be supplied to an issuer during a membership application in a direct or negotiated exchange;
(d) preferred incentives intended to inspire the provision of requested information; and
(e) the destination where personal, registration, and value trust information is to be stored.

4. The method of claim 1 comprising the further step of an issuer publishing the availability of a defined membership program, and an applicant discovering the existence of a membership program and initiating a subscription application.

5. The method according to claim 1 comprising an evaluation of an issuer's information requests with an applicant's data precondition priorities and engaging in an exchange of information to determine the acceptable membership features of highest value to said applicant.

6. The method according to claim 5 comprising the further steps wherein said exchange of information requests and information delivery occurs with the appropriate transmission of available information, restrictions on guarded information, and integration of negotiated information solutions.

7. The method of claim 5 comprising the further steps that the determination of the acceptable membership features of highest value to said applicant are performed with or without user intervention.

8. The method of claim 5 comprising the further steps wherein a ratified membership account that is provided by the issuer to the applicant will involve the issuer storing in such appropriate form and fashion the applicant's information and any complementary value trust in a location as designated by the applicant and allowed by the issuer.

9. The method of claim 5 further comprising the further step of transmitting electronically binding commitments from the one or the more than one issuer and said applicant to consummate said ratified membership account to all related parties.

10. The method of claim 1 further comprising the further step of establishing such electronic and logical linkages as may be required to enable said applicant to process said membership application and to acquire said membership account and associated features with said solution.

11. An apparatus for creating membership solutions by establishing and executing functions that review and determine information exchanges and evaluations to consummate applications, said apparatus comprising:
(a) a processor;
(b) an input device connected to said processor;
(c) an output device connected to said processor;
(d) a clock device connected to said processor;
(e) a logic and control device connected to said processor;
(f) a memory connected to said processor storing programs to control the operation of said processor;
(g) a communications device connected to said processor;
(h) a data storage device connected to said processor;
(i) the processor operative with the program in memory to:
i. record data of users, benefits, solutions, and transactions;
ii. receive requests to process transactions;
iii. enable information to be available to users;
iv. produce solutions;
v. process solutions with and without user intervention;
vi. transmit information to users electronically;
vii. consummate transactions; and,
viii. receive, record, and store user information and transaction activity.

12. An apparatus for creating solutions by establishing and executing functions that review and determine information exchanges and evaluations to consummate transactions, said apparatus comprising:
(a) means for recording data of users, benefits, solutions, and transactions;
(b) means for receiving requests to process transactions;
(c) means for enabling user access to information;
(d) means for producing solutions;
(e) means for processing solutions;
(f) means for transmitting information to users electronically;
(g) means for consummating transactions; and,
(h) means for receiving, recording, and storing user information and transaction activity.

13. The system of claim 12 further comprising computer software for executing functions that review and determine information exchanges and evaluations to consummate transactions, said software comprising processing instructions for directing a computer to perform the steps of:
(a) recording data of users, benefits, solutions, and transactions;
(b) receiving requests to process transactions;
(c) enabling user access to information;
(d) enabling the production of solutions;
(e) processing solutions;
(f) transmitting information to users electronically;
(g) consummating transactions; and,
(h) receiving, recording, and storing user information and transaction activity.
